(19) United States
(12) Patent Application Publication
(10) Pub. No.: US 2022/0188525 A1
(43) Pub. Date: Jun. 16, 2022

(54) DYNAMIC, REAL-TIME COLLABORATION ENHANCEMENT

(71) Applicant: International Business Machines Corporation, Armonk, NY (US)

(72) Inventors: Craig M. Trim, Ventura, CA (US); Shikhar Kwatra, San Jose, CA (US); Mauro Marzorati, Lutz, FL (US); Indervir Singh Banipal, Austin, TX (US)

(21) Appl. No.: 17/120,485

(22) Filed: Dec. 14, 2020

(51) Int. Cl. G06F 40/58; G06F 40/289

(52) U.S. Cl. CPC G06F 40/58; G06F 40/30; G06F 40/289

(57) ABSTRACT

The processor may initiate a media session that includes a first user and a second user. The processor may receive media data associated with the first user. The media data may be in a first expression form. The processor may identify a preferred expression form associated with the second user. The processor may determine an attribute level of the first expression form associated with the first user. The processor may determine a difficulty level of the second user based on one or more attributes of the second user and the media data associated with the first user. The processor may identify whether an understanding threshold has been exceeded, wherein exceeding the understanding threshold is based, on the attribute level and the difficulty level. The processor may display, a translation option to the second user, wherein the translation option is based on the preferred expression form of the second user.

### BACKGROUND

The present disclosure relates generally to the field of user collaboration, and more particularly to multi-lingual understanding collaboration.

Traditional conference call systems connect one or more parties via a communication feed having video and/or audio, allowing collaboration between parties. These systems have become a key component to many workplaces and homes, allowing colleagues and family members to maintain contact regardless of long distances. Despite the growing dependency on conference call systems, most systems remain one dimensional and stagnant and do not address the various components necessary to enable communicate between parties with varied backgrounds.

### SUMMARY

Embodiments of the present disclosure include a method, computer program product, and system for removing an anomaly from a collection of material.

The processor may initiate a media session that includes a first user and a second user. The processor may receive media data associated with the first user. The media data may be in a first expression form. The processor may identify a preferred expression form associated with the second user. The processor may determine an attribute level of the first expression form associated with the first user. The processor may determine a difficulty level of the second user based on one or more attributes of the second user and the media data associated with the first user. The processor may identify whether an understanding threshold has been exceeded, wherein exceeding the understanding threshold is based, on the attribute level and the difficulty level. The processor may display, a translation option to the second user, wherein the translation option is based on the preferred expression form of the second user.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates an exemplary embodiment of a conference call system, in accordance with embodiments of the present disclosure.

FIG. 1B illustrates a block diagram of an example natural language processing system, configured to analyze contextual activity associated with a conference call, in accordance with embodiments of the present disclosure.

FIG. 2 illustrates a flowchart of a method for language translation during a conference call, in accordance with embodiments of the present disclosure.

FIG. 3A illustrates a cloud computing environment, in accordance with embodiments of the present disclosure.

FIG. 3B illustrates abstraction model layers, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of user collaboration, and more particularly to multi-lingual understanding collaboration. While the present disclosure is not necessarily limited to such applications, various aspects of the disclosure may be appreciated through a discussion of various examples using this context.

In today's global environment people have to communicate and coordinate activities with many people who may not speak the same language. While one language may be considered to be the de facto language of a particular area, it is common to come across situations where neither the speaker (e.g., first user) nor the listener (e.g., second user) share a common language. In some situations where a speaker and listener are struggling with a language barrier and understanding each other, frustration between the two or more parties can develop. In these situations, it is often more important that the idea the speaker is attempting to express, is properly conveyed to the listener rather than the specific spoken words. As such, a need for a conference call system that enables real-time translation when either a speaker has trouble speaking the particular language or a listener has trouble understanding the speaker attempting to speak the particular language. Such a system would allow for the speaker to convey the ideas from a speaker to a listener without requiring the speaker to attempt to speak in a possibly unfamiliar language and requiring the listener to attempt to understand the speaker's rendition of the language.

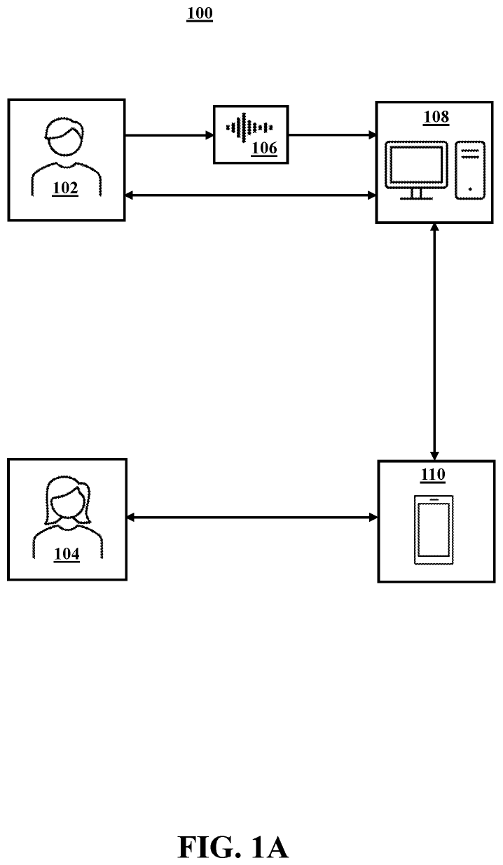

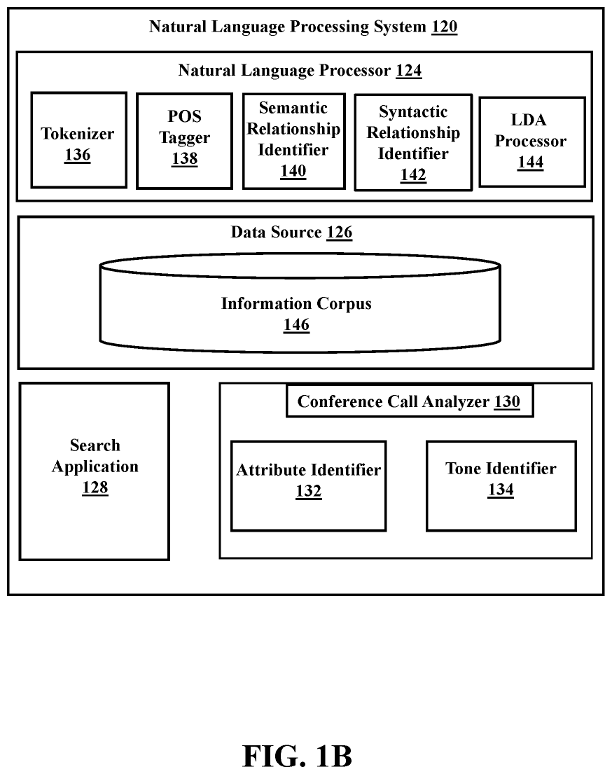

Turning now to the figures, FIG. 1A illustrates an example environment of conference call system 100, in accordance with embodiments of the present disclosure. FIG. 1A provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, conference call system 100 can be configured to relay audio and/or video (e.g., [of] a media session) between any other number of parties participating in the conference call. Each party can have one or more people who can be assigned different roles, such as speaker 102 and listener 104. In some embodiments, the speaker 102 and the listener 104 may be in communication via computer 108 that is associated with speaker 102 and device 110 that is associated with listener 104. In embodiments, speaker 102 can generate voice (e.g., media) data 106 while speaking. Voice data 106 can include any sound, utterance, and/or voice audio produced by speaker 102, while speaker 102 is trying to communicate one or more ideas to listener 104 during the conference call. Voice data 106 can include, but is not limited to, words, expressions, phrases, noises, and/or sound produced by speaker 102 while speaking.

While embodiments discussed herein often refer to one party of the conference call as a speaker 102 and another party as a listener 104, such roles can be switched among parties as traditional conversation exchanges take place during the conference call. For example, in a conference call between multiple parties, one party may include a person who initially has the role of speaker (e.g., speaker 102). In this example, while the person from the one party is the speaker, the other parties may have the role of listeners (e.g., listener 104), where they are listening to the speaker speak. Once the initial speaker (e.g., person from the one party) has concluded speaking, one or more of the other parties (e.g., those parties that were originally listeners) could respond or contribute to the conference call communication and take on the role of speaker while the initial becomes a listener.

In embodiments, the preferred language (e.g., expression form/form of expression) of the speaker and a preferred language of the listener can be determined. A preferred language can be any of one or more languages that the speaker or listener is proficient in (e.g., fluent). For example, a speaker could have a preferred language of Hindi if the speaker is fluent in Hindi, while a listener could have preferred languages of German and French if the listener was fluent in both German and French. In some embodiments, speaker 102 and listener 104 can each provide a sample of voice data 106 in their respective preferred languages. In other embodiments, the preferred language of the speaker can be determined in real-time during the conference call from the voice data spoken by the speaker. In some embodiments, conference call system 100 can receive additional information from outside sources, including, but not limited to various social media platforms. In these embodiments where there is an exchange of roles between the listener and the speaker (e.g., an exchange in conversation) the listener's preferred language can also be determined in real-time. In some embodiments, speaker 102 and listener 104 can further specify a sociolect or dialect as their preferred language.

In embodiments, determination of the preferred languages can include, but is not limited to, using various artificial intelligence techniques, such as a recurrent neural network (RNN) to track one or more speech patterns and/or determine fluency of different languages (e.g., fluency level) from voice data 106 collected during the conference call over time. While in some embodiments, conference call system 100 can be configured to collect voice data 106 over the course of one conference call, in other embodiments, conference call system 100 can be configured to collected voice data 106 from some or all of the conference calls preformed via conference call system 100. In embodiments, conference call system 100 can store collected voice data 106 in one or more databases (e.g., a historical repository). In these embodiments, RNN or other machine learning techniques, such as natural language processing (NLP) and long short-term memory networks (LSTM) can analyze collected voice data 106 and can track the various languages generated during a conference call in a private cloud to detect the one or more most proficient/fluent languages of each speaker and/or listener.

In embodiments, speaker 102 can produce voice audio 106 by speaking any particular language (e.g., first language). Listener 104 can receive voice audio 106 in a particular language via conference call system 100. Conference call system 100 can be configured to determine speaker 102's fluency (e.g., attribute) level of the first language by analyzing voice data 106 for one or more speaker attributes. A speaker attribute can include, but is not limited to one or more physical patterns (e.g., nervous gestures associated with difficulty speaking), or vocal patterns, such as an accent, pauses in speech, and eloquence of speech, identified from voice data 106 by conference call system 100 using methods and techniques contemplated herein. In embodiments, a fluency level can indicate speaker 102's ability to accurately express and articulate their thoughts and ideas in a particular language. For example, a low fluency level would indicate that speaker 102 has a basic or rudimentary ability to speak a particular language, while a high fluency level could indicate that speaker 102 is competent at expressing thoughts and ideas in a particular language.

In embodiments, a fluency level can also indicate whether speaker 102 is fluent within a particular topic. Conference call system 100 can dynamically determine speaker 102's fluency level speaking a first language by analyzing the voice data 106 throughout the conversation. For example, conference call system 100 may include a module (not shown) that can determine speaker 102 has a high fluency level during the initial stages of a conference call where general conversation is exchanged, but then dynamically lower the fluency level when a topic is broached that the speaker is incapable of effectively communicating about (e.g., a technical conversation about mechanical engineering when speaker does not know anything about mechanical engineering). In some embodiments, conference call system 100 can determine speaker 102's fluency level of a particular topic or context by analyzing voice data 106 for one or more speaker attributes, such as long pauses where speaker 102 is trying to remember the correct word or speaker 102 produces various utterances such as “umm” that are indicative of a lack of language proficiency/fluency.

As discussed herein, conference call system 100 can determine speaker 102's fluency level of a particular language (e.g., first language) using various machine learning techniques contemplated herein (e.g., RNN, LSTM, and CNN). In these embodiments, conference call system 100 can observe one or more speaker attributes in voice data 106 of speaker 102 during the conference call. Conference call system 100 can further analyze the one or more speaker attributes. Analyzing, using various machine learning techniques can allow conference call system 100 to properly determine whether the one or more speaker attributes observed are indicative of a high fluency level, a low fluency level, or somewhere in between a low and high fluency level. In embodiments, conference call system 100 can compare the one or more speaker attributes of speaker 102 to a historical repository of speaker attributes. By comparing the one or more speaker attributes to a historical repository of speaker attributes, can allow conference call system 100 to properly determine the fluency level associated with known speaker attributes. In addition, such embodiments can allow conference call system 100 to generate or predict a particular understanding associated with one or more speaker attributes of speaker 102 to predict an accurate fluency level with the one or more speaker attributes are unknown and have not been previously considered by conference call system 100.

In embodiments, conference call system 100 can be configured to determine a difficulty level associated with listener 104 based, at least in part, on one or more listener attributes of listener 104 observed by conference call system 100 during the conference call. In these embodiments, one or more listener attributes of listener 104 can be used to determine if listener 104 is having difficulty understanding speaker 102 speaking a particular language, and, if listener 104 is having difficulty understanding, determining how much difficulty listener 104 is having understanding the voice data 106 received from speaker 102 (e.g., high difficulty level or low difficulty level).

In these embodiments, conference call system 100 can be configured to detect one or more listener attributes (e.g., gestures, use of particular words, emotions, mood, etc.) using various deep neural networks, such as convolutional neural network (CNN) a deep belief networks, and/or tone analyzers (e.g., IBM Watson Tone Analyzer®). In these embodiments, conference call system 100 can be configured to determine whether one or more listener attributed of listener 104 observed during a conference call are indicative of listener 104 understanding the voice data generated by speaker 102. For example, a positive expression expressed by listener 104 (e.g., nodding of the head) could indicate that listener 104 is engaged in the conversation (e.g., conference call) and having a low difficulty level understanding speaker 102 speaking a particular language. Continuing this example, a negative expression expressed by the listener 104 (e.g., listener 104 asking speaker 102 to repeat themselves, etc.) could indicate that listener 104 is having a high difficulty level.

As discussed herein, conference call system 100 can determine listener 104's difficulty level associated with understanding voice data 106 received from speaker 102 during a conference call, using various machine learning techniques contemplated herein (e.g., RNN, LSTM, and CNN). In these embodiments, conference call system 100 can observe one or more listener attributes in data of listener 104 (e.g., video/audio data) observed during the conference call. Conference call system 100 can further analyze the one or more listener attributes. Analyzing, using various machine learning techniques, can allow conference call system 100 to properly determine whether the one or more listener attributes observed during the conference call are indicative of a high difficulty level, a low difficulty level, or somewhere in between a low and high difficulty level.

In embodiments, conference call system 100 can compare the one or more listener attributes of listener 104 to a historical repository of listener attributes. While in some embodiments, listener attributes are stored in the same historical repository as speaker attributes, in other embodiments, listener attributes are stored in separate historical repository from the speaker attributes. By comparing the one or more listener attributes to a historical repository of listener attributes, can allow conference call system 100 to properly determine the difficulty level associated with known listener attributes. In addition, such embodiments can allow conference call system 100 to generate or predict a particular understanding that correlates or is associated with one or more listener attributes of listener 104 to predict an accurate difficulty level with the one or more listener attributes are unknown and have not been previously considered by conference call system 100.

In embodiments, conference call system 100 can be configured to determine whether an understanding threshold is exceeded. In these embodiments, an understanding threshold can be exceeded based, at least in part, on the fluency level and the difficulty level. While in some embodiments a high difficulty level or a low fluency level may independently result in the understanding threshold being exceed, in other embodiments, the difficulty level and the fluency level are considered together. In embodiments, an understanding threshold can be exceeded when speaker 102 cannot adequately express their thoughts and/or ideas in a manner that is understandable when received by listener 104. In embodiments, an understanding threshold can be a different threshold depending on who is speaker 102 and listener 104. For example, in some situations where multiple parties are participating in a conference call, different parties (e.g., having speakers 102 and listeners 104) can have different understanding thresholds that can be applicable during the conference call.

In embodiments, where conference call system 100 has determined the understanding threshold has been exceeded, conference call system 100 can suggest one or more translation options to speaker 102. The one or more translation options can be based, at least in part, on speaker 102's preferred language and listener 104's preferred language. In some embodiments, a translation option can be automatically applied to the conference call depending on the fluency level and difficulty level.

In embodiments, conference call system 100 can provide a translation option where a message or indicator is sent to listener 104 to have the voice data 106 relayed to the listener 104 in the preferred language of listener 104. Conference call system 100 can capture (e.g., continue to capture) voice data 106 of speaker 102 speaking their preferred language and translate voice data 106 (e.g., speaker 102's preferred language) to listener 104's preferred language. In these embodiments, listener 104 receives a translated version of speaker 102's voice data. A translated version of speaker 102's voice data can include, but is not limited to, a computerized translation that is produced for listener 104 to hear and/or a text display of the translated version (e.g., a closed caption displayed on a screen) in listener 104's preferred language. As such, conference call system 100 can suggest one or more translation option that can ensure the fluency level and the difficulty level are of sufficient levels to allow thoughts and information to be accurately conveyed during the conference call.

In some embodiments having particularly high difficulty levels and particularly low fluency levels, conference call system 100 can automatically switch the conference call to this configuration to ensure adequate communication during the conference call. For example, speaker 102 could attempt to speak a first language during the conference call. This first language could be a language common to both speaker 102 and listener 104 or could be speaker 102's attempt at speaking listener 104's preferred language. In embodiments where the first language spoken by speaker 102 is the same language as listener 104's preferred language, the understanding threshold can still be exceeded due to speaker 102's fluency level resulting in listener 104 exhibiting a high difficulty (of understanding) level. Continuing this example, when the understanding threshold is exceeded during the conference call, conference call system 100 can indicate to speaker 102 (e.g., by sending a message) to begin speaking in their preferred language (e.g., Spanish). Conference call system 100 can then translate the voice data 106 received from speaker 102 speaking their preferred language and translate the captured voice data in Spanish to a preferred language of listener 104 (e.g., French).

In some embodiments, conference call system 100 can provide a second type of translation option to speaker 102 while speaker 102 is speaking a particular language. As discussed herein, conference call system 100 can analyze one or more listener attributes during a conference call. Analyzing these one or more listener attributes can allow conference call system 100 to identify an expression from voice data 106 of speaker 102 that resulted in the understanding threshold being exceeded. For example, speaker 102 can be speaking first language that can be common between listener 104 and speaker 102.

In embodiments, conference call system 100 can analyze voice data 106 and one or more listener attributes of listener 104 (e.g., raising of an eyebrow) to determine that a particular phrase/expression from the conversation causes the understanding threshold to be exceeded. In these embodiments, conference call system 100 can provide speaker 102 with a list of alternative phrases/expressions in the particular language (e.g., first language) that may correlate to the phrase/expression speaker 102 wants to say, but that was unfamiliar to listener 104.

In many embodiments, because the difficulty level is only increased when the particular phrase/expression is observed in voice data 106, the understanding threshold may only be exceeded when an unfamiliar phrase/expression is uttered by speaker 102. In these embodiments, once the difficulty level associated with the unknown phrase/expression is rectified, the understanding threshold may once again return to the same level prior to identifying the unknown phrase/expression. In some embodiments, speaker 102 may already be speaking in their preferred language that is then translated (e.g., into a translated version) and provided to listener 104 in listener 104's preferred language.

In these embodiments, speaker 102 may use a phrase/expression that is commonly used in their preferred language, but when the phrase/expression is directly translated into listener 104's preferred language the meaning is unclear. As such, conference system 100 can analyze voice data 106 and one or more listener attributes of listener 104 to determine that listener 104's difficulty level has increased, resulting in the understanding threshold being exceeded. As such, when the understanding threshold is exceeded is this manner, conference call system 100 can identify that the phrase/expression is not understood by listener 104 and generate a list of one or more alternative expressions that can be understood by listener 104. In some embodiments, when listener 104 receives an alternative expression from speaker 102 and understands the meaning (e.g., based on one or more listener attributes) the difficulty level is reduced, and the understanding threshold is no longer exceeded.

In some embodiments, conference call system 100 can provide a third type of translation option to speaker 102 while speaker 102 is speaking a particular language (e.g., first language) to listener 104. In embodiments, conference call system 100 can provide speaker 102 with one or more translation options that can be derived from controlled languages and constructed languages (e.g., formalized languages). Controlled languages, also known as alternative/auxiliary languages are major languages that have been codified to provide aid to non-native speakers. Controlled languages may include, but are not limited to, Basic English, International English, Simplified Technical English, Globish, Special English and Francois Fondamental. Constructed languages are languages that aim to provide a speaker with zonal interoperability (e.g., Interlingua, Toutonish, Slovio, and Interslavic). While in some embodiments, one or more of the aforementioned controlled or constructed languages can be accessed by conference call system 100 to provide aid to speaker 102 when speaking to a particular language (e.g., first language), in other embodiments, conference call system 100 can analyze voice data 106 from a historical repository and use one or more of the controlled or constructed languages to predict words that might be used by speaker 102 during the conference call.

In embodiments, conference call system 100 can analyze and determine common speech patterns of speaker 102. In these embodiments, conference system 100 can use these common speech patterns to predict what words or phrases may be needed by speaker 102 to aid them while speaking first language or any particular language during the conference call. These predictions can be generated on a screen viewable to speaker 102 during the conference call.

In embodiments, conference call system 100 can inspect the audio and/or video associated with the conference call and analyze the collected date to identify new or unknown listeners who have entered an operating zone of the conference call. A new or unknown listener could be a person who has entered the area (e.g., a conference room) where speaker 102 or listener 104 is inhabiting during the conference call. An operating zone associated with the conference call can include any area where the information exchanged during the conference call can be heard or viewed by one or more people that are not participating in the conference call. Conference call system 100 can use the various machine learning techniques contemplated herein to identify if a new or unknown listener has entered the operating zone of the conference call and determine whether the new/unknown listener is an authorized listener or an unauthorized listener. For example, conference call system 100 can determine if a new/unknown listener is an authorized listener by comparing one or more listener attributes and/or one or more speaker attributes to a historical repository of prior conference calls. In embodiments, conference call system 100 can determine from the historical patterns identified after analyzing the historical repository if a new/unknown listener has previously been allowed to participate in a conference call.

In some embodiments, conference call system 100 can determine the new/unknown listener is an authorized listener or an unauthorized listener based on observed historical patterns of prior conference calls analyzed from the historical repository. If conference call 100 determines the new/unknown listener is an authorized listener, the new/unknown listener can then participate in the conference call. In some embodiments, conference call system 100 can analyze voice data 106 observed during the conference call and determine if any confidential or sensitive information has been exchanged. In these embodiments, if conference call system 100 determines that confidential or sensitive information has been exchanged, the conference call can be configured switch to a confidential mode. A confidential mode can include, but is not limited to, muting voice audio 106 generated by speaker 102, transcribing the voice audio to a transcript (e.g., closed caption) that is only displayed to authorized listeners (e.g., listener 104), sending an indicator (e.g., message) that a possible breach of confidential material has occurred, or any combination thereof.

In other embodiments, conference call system 100 can provide an indicator to the other participating parties (e.g., speakers and listeners) that a new/unknown listener has entered the operating zone. Once an indicator has been received by the participating parties, the participating parties can decide whether the new/unknown listener is an authorized listener or an unauthorized listener. In embodiments where conference call system 100 can determine that the new/unknown listener is an authorized listener, conference call system 100 can detect the authorized listener's preferred language to ensure the authorized listener is able to participate in the understanding or exchange of information during the conference call. Such preferred languages can be included in the historical repository and can be used in future analyses. In embodiments where conference call system 100 identifies the initially new/unknown listener as an authorized listener, conference call system 100 can fetch various information from the historical repository associated with the authorized listener if they have previously participated in a conference call. This information can include one or more listener attributes (e.g., and one or more speaker attributes if the authorized listener exchanges their listening role for a speaking role) and their one or more preferred language.

As discussed herein, conference calls can connect two or more parties, having one or more people associated with each party, and allow the different parties to exchange information and conversation. A party can refer to the operating zone where one or more people are in an operating zone participating in the conference call. While embodiments discussed herein refer to two parties generally as speaker 102 and listener 104, such designations are used to designate roles that can be exchanged during a conference call. For example, a first party having speaker 102, and a second party having listener 104 can participate in a conference call. In this example, speaker 102 of the first party can provide a presentation to listener 104 of the second party. Once finished, the second party can exchange the role of listener 104 with the first party's role of speaker 102 and ask questions about the first party's presentation. As such, the first party can take on the role of listener 104 and the second party can accept the role of speaker 102. This exchange of roles can continue throughout the duration of the conference call.

In some embodiments, one or more participating parties to a conference call can include more than one person. In these embodiments, each person within a participating party can have a speaker 102 or listener 104 roles that can be exchanged as traditional conversational norms progress during the conference call. As such, each person can have a determined fluency level and a difficulty level that can be applied depending on if the person is acting in a speaker 102 role or a listener 104 role. Accordingly, each person (e.g., having a listener 104 role) can have different understanding thresholds that can be exceeded with different configurations of fluency level and difficulty level depending on the person's particular preferred languages and the preferred languages of the other parties participating (e.g., comprising one or more people) in the conference call. As such, while embodiments discussed herein may generally refer to speaker 102 and listener 104 as separate parties, such indications of separate or distinctness is incorporated for clarity only and it should be understood that any person associated with a participating party can take on any configuration of the role of speaker 102 and/or listener 104 as natural conversational patterns are evoked during the conference call, as discussed herein.

In embodiments where two or more parties to a conference call have one or more people participating, each person can have a different preferred language. In these embodiments, a display can be configured to provide transcripts (e.g., closed caption) of voice data (e.g., voice data 106) of one or more speakers (e.g., speaker 102) translated into multiple languages. These multiple languages can be displayed when one or more listeners' (e.g., listener 104) understanding thresholds are exceeded based on each person's (e.g., listener's) determined difficulty level. In response to the exceeding a person's understanding threshold, the voice data of the one or more speakers can be translated into a person's detected preferred language. Each person's preferred language can be displayed on one or more screens in a closed caption or transcript format. Such embodiments can ensure that information is accurately and proficiently exchanged between and among each participating party to the conference call.

In embodiments, conference call system 100 can be configured to interpret various programming languages and offer suggested translation options to the participating parties of a conference call. For example, during a conference call participating parties may discuss syntax or semantics of one or more programming languages. These programming languages can include, but are not limited to, C++, C, Java, and Python. In this example each person participating in the conference call can have preferred language and an additional preferred language. The additional preferred language can be the programing language preferred by the person when they are receiving information from a speaker (e.g., speaker 102). For example, a listener 104 may have a preferred language of English and an additional preferred language of Java. Continuing this example, speaker 102 can have a preferred language of English and an additional preferred language of C++. In this example, while information is being exchanged in English during the conference call, if speaker 102 attempts to discuss various C++ syntax, conference call system 100 can determine that listener 104 is having difficulty understanding what speaker 102 is referencing causing an increase in difficulty level for listener 104. This can result in the understanding threshold being exceeded. In this example, conference call system 100 can translate the syntax from C++ to Java so that listener 104, who is unfamiliar with C++ can understand the context and continue the exchange of information during the conference call.

FIG. 1B illustrates a block diagram of a natural language processing system 120, configured to contextually analyze contextual activity associated with audio and video feeds during a conference call, in accordance with embodiments of the present disclosure. In some embodiments, conference call system 100 may submit a communication feed (e.g., voice data and video data) associated with a conference call to be analyzed by natural language processing system 120. Natural language processing system 120 can use the voice data and conference call data (e.g., audio data and/or video data) to identify particular attributes (e.g., one or more listener attributes and one or more speaker attributes) and determine an understanding of possible tones from the voice data. In some embodiments, natural language processing system 120 can include a text-to-speech analyzer, allowing voice data (e.g., voice data 106 of speaker 102) to be transcribed. In these embodiments the transcribed voice data can then be analyzed by natural language processing system 120. In embodiments, conference call system 100 can display text or closed caption of a voice data received by a listener (e.g., listener 102). In these embodiments, natural language processing system 120 can be further configured to receive electronic documentation of the display and proceed with analyzing the closed caption.

In some embodiments, the natural language processing system 120 can include a natural language processor 124, data sources 126, a search application 128, and a conference call analyzer 130. Natural language processor 124 can be a computer module that analyzes the received unstructured textual conversation transcript(s) of the voice data and other electronic documents. Natural language processor 124 may perform various methods and techniques for analyzing the voice data of conference call (e.g., syntactic analysis, semantic analysis, etc.). Natural language processor 124 may be configured to recognize and analyze any number of natural languages. In some embodiments, the natural language processor 124 may parse one or more sections of a transcribed voice data activity into one or more subdivisions.

Further, the natural language processor 124 may include various modules to perform analyses of transcribed contextual activity. These modules may include, but are not limited to, a tokenizer 136, a part-of-speech (POS) tagger 138 (e.g., which may tag each of the one or more subdivisions in which storage requirements and/or storage costs are identified), a semantic relationship identifier 140, and a syntactic relationship identifier 142.

In some embodiments, the tokenizer 316 may be a computer module that performs lexical analysis. The tokenizer 316 may convert a sequence of characters (e.g., images, sounds, etc.) into a sequence of tokens. A token may be a string of characters included in a contextual activity (e.g., conversation) and categorized as a meaningful symbol. Further, in some embodiments, the tokenizer 136 may identify word boundaries in the contextual activity and break any text within the contextual activity into their component text elements, such as words, multiword tokens, numbers, and punctuation marks. In some embodiments, the tokenizer 136 may receive a string of characters, identify the lexemes in the string, and categorize them into tokens.

In some embodiments, in addition to the tokenizer 136 and/or separately from the tokenizer 136, the natural language processing system 120 may include a component that performs document to vector natural language processing functions. For example, transcribed voice data can be parsed into their component words and the words will subsequently be transformed into associated vectors that will then be used for natural language analysis.

Consistent with various embodiments, the POS tagger 138 may be a computer module that marks up a word in a recording to correspond to a particular part of speech. The POS tagger 138 may read a passage or other text in natural language and assign a part of speech to each word or other token. The POS tagger 138 may determine the part of speech to which a word corresponds based on the definition of the word and the context of the word. The context of a word may be based on its relationship with adjacent and related words in a phrase, sentence, or paragraph. In some embodiments, the context of a word may be dependent on one or more previously analyzed voice data sets (e.g., the voice data activity associated with prior conference calls may shed light on the meaning of one or more possible contextual situations in another conference call). Examples of parts of speech that may be assigned to words include, but are not limited to, nouns, verbs, adjectives, adverbs, and the like. Examples of other part of speech categories that POS tagger 138 may assign include, but are not limited to, comparative or superlative adverbs, wh-adverbs, conjunctions, determiners, negative particles, possessive markers, prepositions, wh-pronouns, and the like. In some embodiments, the POS tagger 138 may tag or otherwise annotate tokens of the contextual activity with part of speech categories. In some embodiments, the POS tagger 138 may tag tokens or words of a recording to be parsed by the natural language processing system 120.

In some embodiments, the semantic relationship identifier 140 may be a computer module that may be configured to identify semantic relationships of recognized subjects (e.g., words, phrases, videos, images, etc.) in the voice data. In some embodiments, the semantic relationship identifier 140 may determine functional dependencies between entities and other semantic relationships.

Consistent with various embodiments, the syntactic relationship identifier 142 may be a computer module that may be configured to identify syntactic relationships from the contextual activity of a communication feed, composed of tokens. The syntactic relationship identifier 142 may determine the grammatical structure of sentences such as, for example, which groups of words are associated as phrases and which word is the subject or object of a verb. The syntactic relationship identifier 142 may conform to formal grammar.

In embodiments, natural language processor 124 can be configured to include Latent Dirichlet Allocation (LDA) processor 144. While in some embodiments LDA processor 144 can be configured to work with one or more of the other components pertaining to natural language processor 124 to identify contextual situations from contextual activity, in other embodiments LDA processor 144 performs all the analysis for natural language processor 124. LDA processor 144 can generally be understood to be a generative statistical model that implements aspects of machine learning to enable topic modeling of a given situation (e.g., determining a contextual situation from contextual activity) and/or keyword processing. LDA processor 144 can include, but is not limited to the following stages: i) tokenization; ii) stop word removal; iii) lemmatizing (e.g., changing words in third person to first person and verbs having a past or future tense to the present tense); and iv) stemming (e.g., reducing words to their root form).

In some embodiments, the natural language processor 124 may be a computer module that may group sections of the contextual activity into subdivisions and generate corresponding data structures for one or more subdivisions of the contextual activity. For example, in response to receiving the voice data sets at the natural language processing system 120 via conference call system 100, the natural language processor 124 may output parsed text elements from the report as data structures. In some embodiments, a subdivision may be represented in the form of a graph structure. To generate the subdivision, the natural language processor 124 may trigger computer modules 136-144.

In some embodiments, the output of natural language processor 124 may be used by search application 128 to perform a search of a set of (e.g., one or more) corpora to retrieve one or more subdivisions including a particular requirement associated with the voice data activity and send the output (e.g., fluency level and/or difficulty level) to a word processing system and to a comparator. As used herein, a corpus may refer to one or more data sources, such as data sources 126. In some embodiments, data sources 126 may include video libraries, data warehouses, information corpora, data models, and document repositories, and a historical repository of communication feed associated with conference call system 100. In some embodiments, data sources 126 may include an information corpus 144. Information corpus 144 may enable data storage and retrieval. In some embodiments, information corpus 144 may be a subject repository that houses a standardized, consistent, clean, and integrated list of words, images, and dialogue. The data may be sourced from various operational systems. Data stored in information corpus 144 may be structured in a way to specifically address reporting and analytic requirements. In some embodiments, information corpus 144 may be a relational database or a text index.

In some embodiments, the attribute analyzer (e.g., one or more speaker attributes and/or one or more listener attributes) may be a computer module that elucidates fluency levels and/or difficulty levels by identifying conversational topics and/or related components among the voice and video data of the conference call. In some embodiments, the conference call analyzer 130 may include an attribute identifier 132 and a tone identifier 134. When the voice data and/or conference call data (e.g., audio and video data of the conference call) is received by the natural language processing system 120, the conference call analyzer 130 may be configured to analyze the voice data using natural language processing, and in some embodiments LDA processing, to identify a particular contextual situation. In some embodiments, a conference call a conference call analyzer 130 may first identity one or more requirements in the contextual activity using the natural language processor 124 and related subcomponents 136-144.

After identifying a particular portion of voice data, collected during the conference call, using the attribute identifier 132, the tone identifier 134 can then be configured to analyze the video data and the associated contextual activity immediately surrounding the contextual situation associated with a particular topic to determine or identify one or more attributes that can be used to determine a fluency level and difficulty level. While in some embodiments attributes (e.g., one or more speaker attributes and/or one or more listener attributes) are determined by a conference call analyzer 130 of natural language processing system 101, in other embodiments various attributes can be determined using deep learning and machine learning models (e.g., Bi-LSTM and R-CNN ML models), or any combination of techniques discussed herein. While not specifically identified herein, a conference call analyzer 130 can also have additional sub-components configured to aid attribute identifier 132 and tone identifier, sentiment analysis, and question answering.

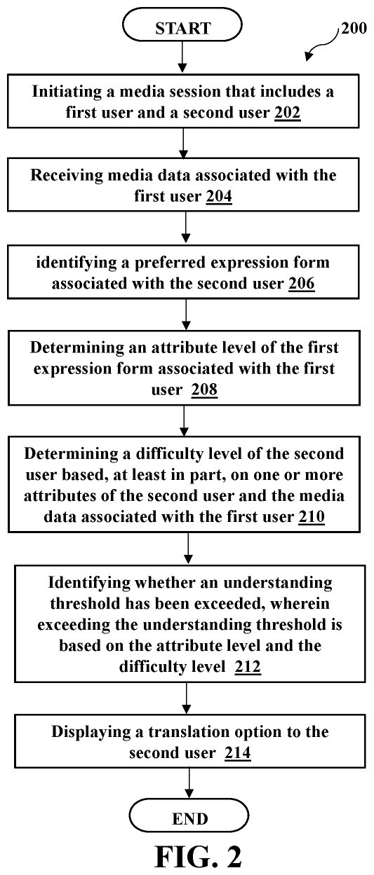

Referring now to FIG. 2, a flowchart illustrating an example method 200 for language translation during a conference call, in accordance with embodiments of the present disclosure. In some embodiments, the method 200 may be used to perform language morphing or language translation in real-time during a conference call.

In some embodiments, the method 200 begins at operation 202 where a processor initiates a media session that includes a first user and a second user. The method 200 proceeds to operation 204. At operation 204, the processor receives media data associated with the first user. The method 200 proceeds to operation 206. At operation 206, the processor identifies a preferred expression form associated with the second user. The method 200 proceeds to operation 208. At operation 208, the processor determines an attribute level of the first expression form associated with the first user. The method 200 proceeds to operation 210. At operation 210 the processor determines a difficulty level of the second user based on one or more attributes of the second user and the media data associated with the first user. The method 200 proceeds to operation 212. At operation 212, the processor identifies whether an understanding threshold has been exceeded, wherein exceeding the understanding threshold is based, on the attribute level and the difficulty level. The method 200 proceeds to operation 214. At operation 214, the processor displays a translation option to the second user, wherein the translation option is based on the preferred expression form of the second user. In some embodiments, as depicted inf FIG. 2, after operation 212, the method 200 may end.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

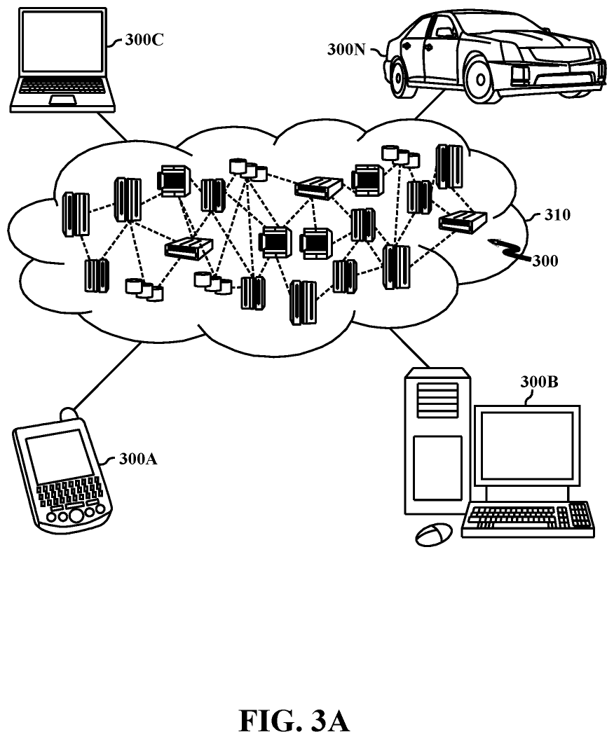

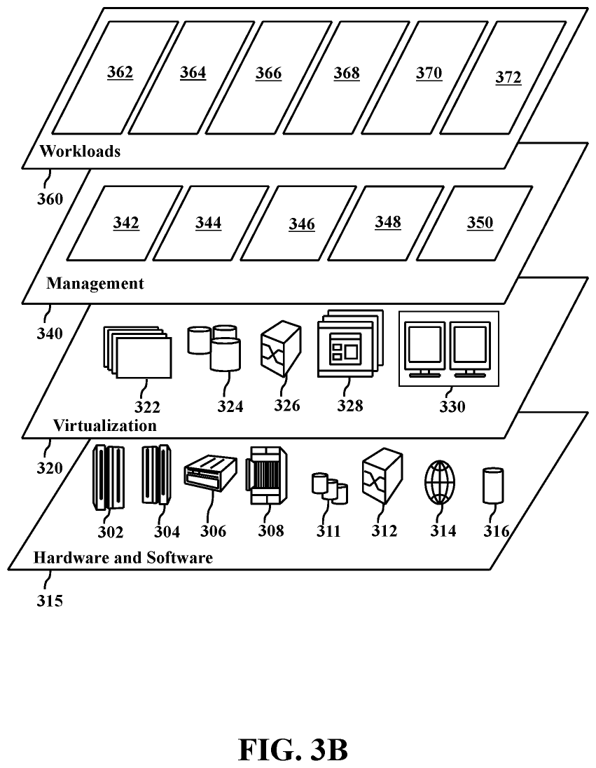

Referring now to FIG. 3A, illustrative cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof. This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing 300 and cloud computing environment 310 can communicate with any type of computerized device over any type of network and/or network addressable connection (e.g., using a web browser).

Referring now to FIG. 3B, a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and real-time language translation 372.

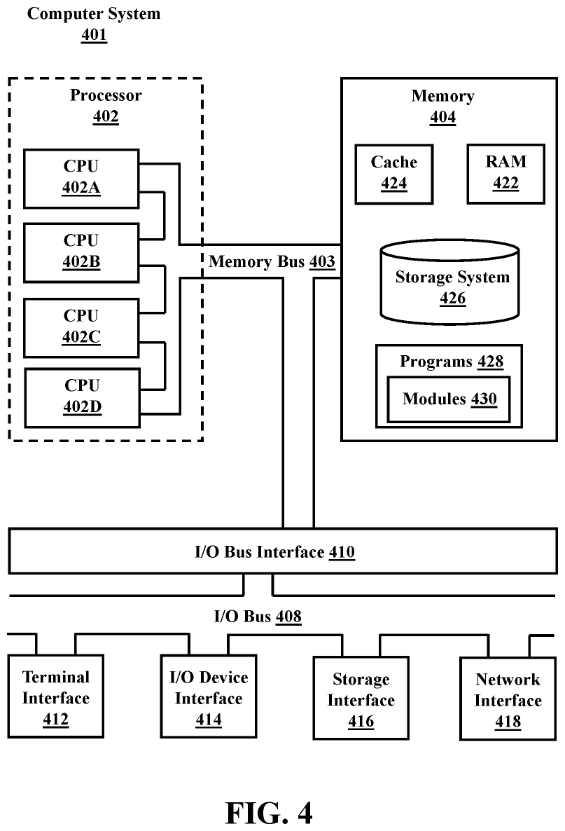

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present invention. In some embodiments, the major components of the computer system 401 may comprise one or more Processor 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
initiating, by a processor, a media session that includes a first user and a second user;
receiving media data associated with the first user, wherein the media data is in a first expression form;
identifying a preferred expression form associated with the second user;
determining an attribute level of the first expression form associated with the first user;
determining a difficulty level of the second user based, at least in part, on one or more attributes of the second user and the media data associated with the first user;
identifying whether an understanding threshold has been exceeded, wherein exceeding the understanding threshold is based, at least in part, on the attribute level and the difficulty level;
displaying, responsive to exceeding the understanding threshold, a translation option to the second user, wherein the translation option is based, at least in part, on the preferred expression form of the second user.

2. The method of claim 1, wherein determining the attribute level of the first user includes:
detecting one or more attributes associated with the first user in the media data associated with the first user;
analyzing the one or more attributes;
comparing the one or more attributes to a historical repository of attributes; and
generating an understanding of the one or more attributes associated with the first user.

3. The method of claim 2, wherein suggesting the translation option further includes:
prompting the first user to provide second media data in the preferred expression form;
capturing the media data associated with the first user during the media session; and
translating the media data associated with the first user to the second the preferred expression form.

4. The method of claim 1, wherein determining the difficulty level of the second user includes:
detecting the one or more attributes of the second user during the media session;
analyzing the one or more attributes of the second user;
comparing the one or more attributes of the second user to a historical repository of attributes; and
generating an understanding of the one or more listener attributes of the second user.

5. The method of claim 4, wherein suggesting a translation option includes:
analyzing the one or more attributes of the second user, responsive to the second user receiving the media data of the first user in the first expression form;
identifying a phrase from the media data associated with the first user;
identifying that the phrase, causes the understanding threshold to be exceeded; and
providing the first user with a list of alternative phrases that correlate to the expression, wherein the list of alternative expressions is the translation option.

6. The method of claim 1, further comprising:
displaying a text, wherein the text is a translation of the media data associated with the first user in the preferred expression form of the second user.

7. The method of claim 1, wherein a text of the media data associated with the first user is displayed to two or more other users in multiple languages.

8. A system, the system comprising:
a memory; and
a processor in communication with the memory, the processor being configured to perform operations comprising:
initiating, by a processor, a media session that includes a first user and a second user;
receiving media data associated with the first user, wherein the media data is in a first expression form;
identifying a preferred expression form associated with the second user;
determining an attribute level of the first expression form associated with the first user;
determining a difficulty level of the second user based, at least in part, on one or more attributes of the second user and the media data associated with the first user;
identifying whether an understanding threshold has been exceeded, wherein exceeding the understanding threshold is based, at least in part, on the attribute level and the difficulty level;
displaying, responsive to exceeding the understanding threshold, a translation option to the second user, wherein the translation option is based, at least in part, on the preferred expression form of the second user.

9. The system of claim 8, wherein determining the attribute level of the first user includes:
detecting one or more attributes associated with the first user in the media data associated with the first user;
analyzing the one or more attributes;
comparing the one or more attributes to a historical repository of attributes; and
generating an understanding of the one or more attributes associated with the first user.

10. The system of claim 9, wherein suggesting the translation option further includes:
prompting the first user to provide second media data in the preferred expression form;
capturing the media data associated with the first user during the media session; and
translating the media data associated with the first user to the second the preferred expression form.

11. The system of claim 8, wherein determining the difficulty level of the second user includes:
detecting the one or more attributes of the second user during the media session;
analyzing the one or more attributes of the second user;
comparing the one or more attributes of the second user to a historical repository of attributes; and
generating an understanding of the one or more listener attributes of the second user.

12. The system of claim 11, wherein suggesting a translation option includes:
analyzing the one or more attributes of the second user, responsive to the second user receiving the media data of the first user in the first expression form;
identifying a phrase from the media data associated with the first user;
identifying that the phrase, causes the understanding threshold to be exceeded; and
providing the first user with a list of alternative phrases that correlate to the expression, wherein the list of alternative expressions is the translation option.

13. The system of claim 8, the processor being further configured to perform operations comprising:
displaying a text, wherein the text is a translation of the media data associated with the first user in the preferred expression form of the second user.

14. The system of claim 8, wherein a text of the media data associated with the first user is displayed to two or more other users in multiple languages.

15. A computer program product, the computer program product comprising a computer readable storage medium having program instructions embodied therewith, the program instructions executable by a processor to cause the processors to perform a function, the function comprising:
initiating, by a processor, a media session that includes a first user and a second user;
receiving media data associated with the first user, wherein the media data is in a first expression form;
identifying a preferred expression form associated with the second user;
determining an attribute level of the first expression form associated with the first user;
determining a difficulty level of the second user based, at least in part, on one or more attributes of the second user and the media data associated with the first user;
identifying whether an understanding threshold has been exceeded, wherein exceeding the understanding threshold is based, at least in part, on the attribute level and the difficulty level;
displaying, responsive to exceeding the understanding threshold, a translation option to the second user, wherein the translation option is based, at least in part, on the preferred expression form of the second user.

16. The computer program product of claim 15, wherein determining the attribute level of the first user includes:
detecting one or more attributes associated with the first user in the media data associated with the first user;
analyzing the one or more attributes;
comparing the one or more attributes to a historical repository of attributes; and
generating an understanding of the one or more attributes associated with the first user.

17. The computer program product of claim 16, wherein suggesting the translation option further includes:
prompting the first user to provide second media data in the preferred expression form;
capturing the media data associated with the first user during the media session; and
translating the media data associated with the first user to the second the preferred expression form.

18. The computer program product of claim 15, wherein determining the difficulty level of the second user includes:
detecting the one or more attributes of the second user during the media session;
analyzing the one or more attributes of the second user;
comparing the one or more attributes of the second user to a historical repository of attributes; and
generating an understanding of the one or more listener attributes of the second user.

19. The computer program product of claim 18, wherein suggesting a translation option includes:
analyzing the one or more attributes of the second user, responsive to the second user receiving the media data of the first user in the first expression form;
identifying a phrase from the media data associated with the first user;
identifying that the phrase, causes the understanding threshold to be exceeded; and
providing the first user with a list of alternative phrases that correlate to the expression, wherein the list of alternative expressions is the translation option.

20. The computer program product of claim 15, the processor being further configured to perform functions comprising:
displaying a text, wherein the text is a translation of the media data associated with the first user in the preferred expression form of the second user.
